(19) United States
(12) Patent Application Publication
(10) Pub. No.: US 2025/0371321 A1
(43) Pub. Date: Dec. 4, 2025

(54) SYSTEMS AND METHODS FOR OPTIMIZING LARGE LANGUAGE MODEL BASED APPLICATIONS

(71) Applicant: Verizon Patent and Licensing Inc., Basking Ridge, NJ (US)

(72) Inventors: Farid KHAFIZOV, Plano, TX (US); Art ZAIFMAN, Millburn, NJ (US)

(73) Assignee: Verizon Patent and Licensing Inc., Basking Ridge, NJ (US)

(21) Appl. No.: 18/675,539

(22) Filed: May 28, 2024

(51) Int. Cl. G06N 3/0475

(52) U.S. Cl. CPC G06N 3/0475

(57) ABSTRACT

A device may receive a plurality of documents and a plurality of questions for the plurality of documents, and may determine a plurality of ground truth answers corresponding to the plurality of questions. The device may normalize the plurality of questions to generate a normalized plurality of questions, and may select a set of most frequent questions from the normalized plurality of questions. The device may utilize regular expressions and natural language processing to generate, from the plurality of ground truth answers, a set of answers to the set of most frequent questions, and may dynamically select prompts for LLMs based on the set of most frequent questions and based on context provided to the LLMs. The device may optimize, based on the set of most frequent questions, the set of answers, the prompts, and parameters of configurations for the LLMs, accuracies of the LLMs to generate optimized LLMs.

### BACKGROUND

The field of human-computer interaction includes systems that facilitate communication between users and user devices (e.g., communication and/or computing devices). Advancements in this field include the creation and refinement of large language models (LLMs) that process and respond to user inputs in a manner that is intended to be contextually appropriate.

### BRIEF DESCRIPTION OF THE DRAWINGS

FIGS. 1A-1F are diagrams of an example associated with optimizing LLM based applications.

FIG. 2 is a diagram of an example environment in which systems and/or methods described herein may be implemented.

FIG. 3 is a diagram of example components of one or more devices of FIG. 2.

FIG. 4 is a flowchart of an example process for optimizing LLM based applications.

### DETAILED DESCRIPTION OF EXAMPLE EMBODIMENTS

The following detailed description of example implementations refers to the accompanying drawings. The same reference numbers in different drawings may identify the same or similar elements.

LLMs have revolutionized the field of artificial intelligence by providing advanced capabilities for generating human-like responses to questions. LLMs rely on carefully constructed prompts to elicit specific outputs, solutions, and/or actions based on a received input. In one example, LLMs may be utilized with a system for storing and examining documents, such as root cause analysis (RCA) documents (e.g., documents that include valuable information related to failures during testing of new software, features, and new hardware). The system may enable engineers to ask questions about a specific RCA document or a set of RCA documents. However, LLMs are difficult to optimize and poorly designed LLMs are very inefficient. LLM optimizations may vary from one LLM to another LLM. Thus, current techniques for utilizing LLMs consume computing resources (e.g., processing resources, memory resources, communication resources, and/or the like), networking resources, and/or other resources associated with LLMs failing to properly answer questions appropriately and efficiently, LLMs providing incorrect recommendations based on poorly designed LLMs, LLMs providing irrelevant and inaccurate responses based on poorly designed LLMs, and/or the like.

Some implementations described herein provide an RCA system that optimizes LLM based applications. For example, the RCA system may receive a plurality of documents and a plurality of questions associated with the plurality of documents, and may determine a plurality of ground truth answers corresponding to the plurality of questions. The RCA system may normalize the plurality of questions to generate a normalized plurality of questions, and may select a set of most frequent questions from the normalized plurality of questions. The RCA system may utilize regular expressions and natural language processing to generate, from the plurality of ground truth answers, a set of answers to the set of most frequent questions, and may dynamically select prompts for LLMs based on the set of most frequent questions and based on context provided to the LLMs for generating the set of answers. The RCA system may optimize, based on the set of most frequent questions, the set of answers, the prompts, and parameters of configurations for the LLMs, accuracies of the LLMs to generate optimized LLMs, and may implement the optimized LLMs for the plurality of questions associated with the plurality of documents.

In this way, the RCA system optimizes LLM-based applications. For example, the RCA system may automatically improve a quality of a question and answer system or any other system that is based on LLMs. The RCA system may start with a set of questions referencing specific documents, and may identify and store a correct answer (e.g., a ground truth) for each question. The RCA system may include multiple configurations for the LLMs, and each configuration may include multiple parameters. The RCA system may generate a search grid for discrete values of each parameter within a specified range to enable the RCA system to identify a best value of a parameters space. The RCA system may select multiple configurations for multiple LLMs (e.g., for three models and two configurations, the RCA system may generate six model-configuration combinations). Thus, the RCA system may conserve computing resources, networking resources, and/or other resources that would have otherwise been consumed by LLMs failing to properly answer questions appropriately and efficiently, LLMs providing incorrect recommendations based on poorly designed LLMs, LLMs providing irrelevant and inaccurate responses based on poorly designed LLMs, and/or the like.

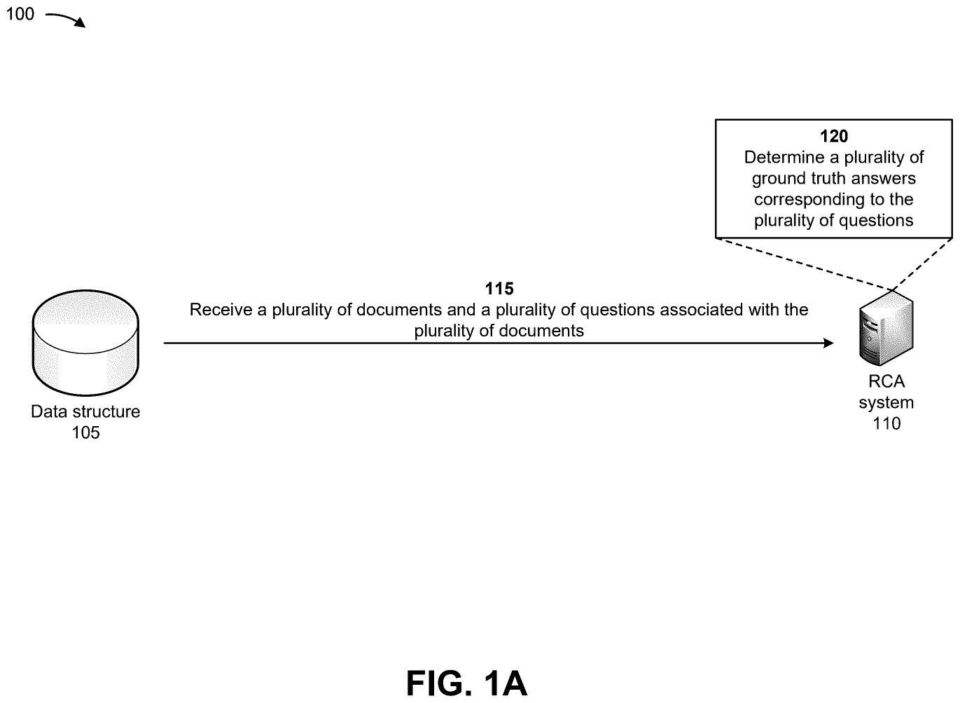

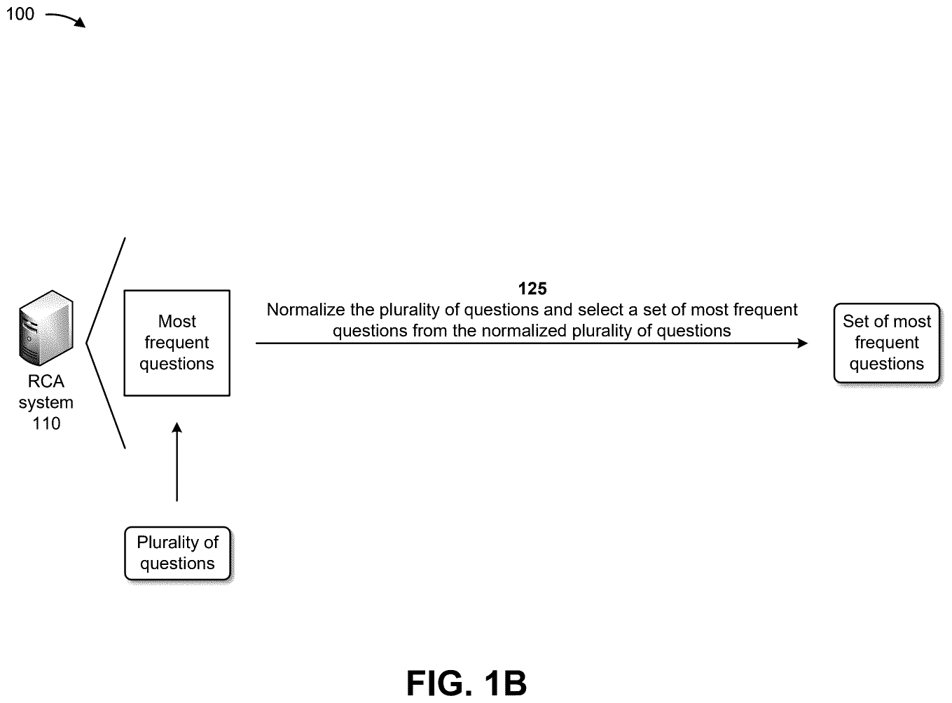

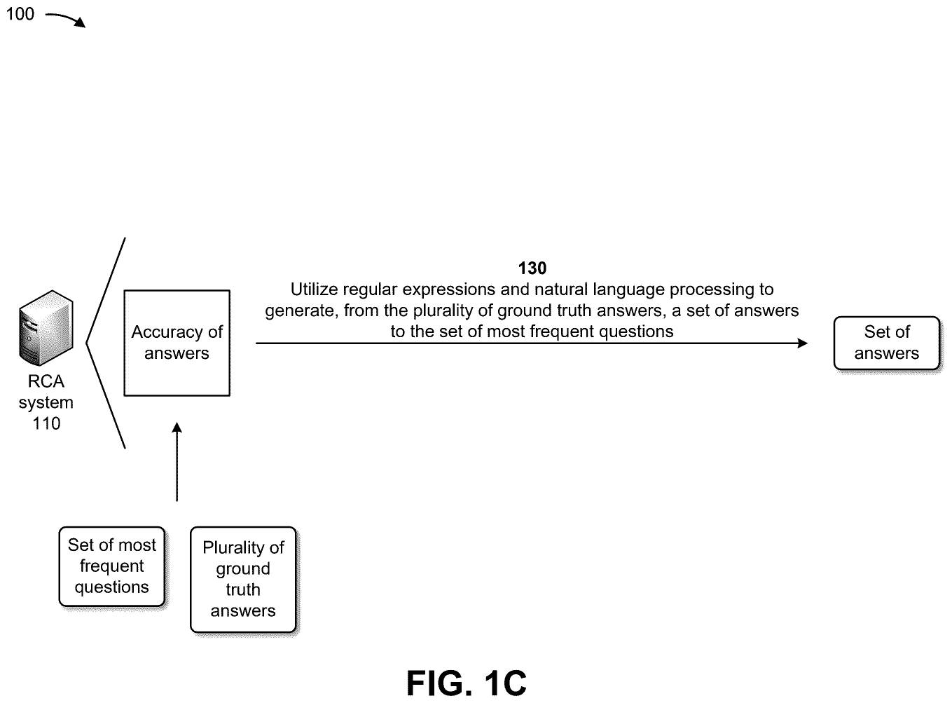

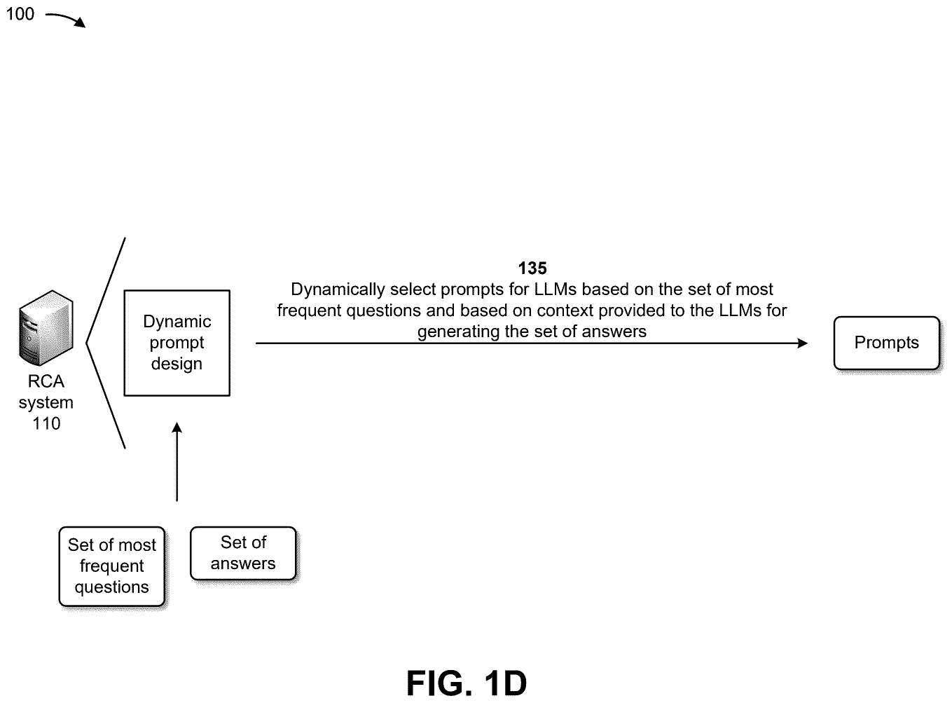

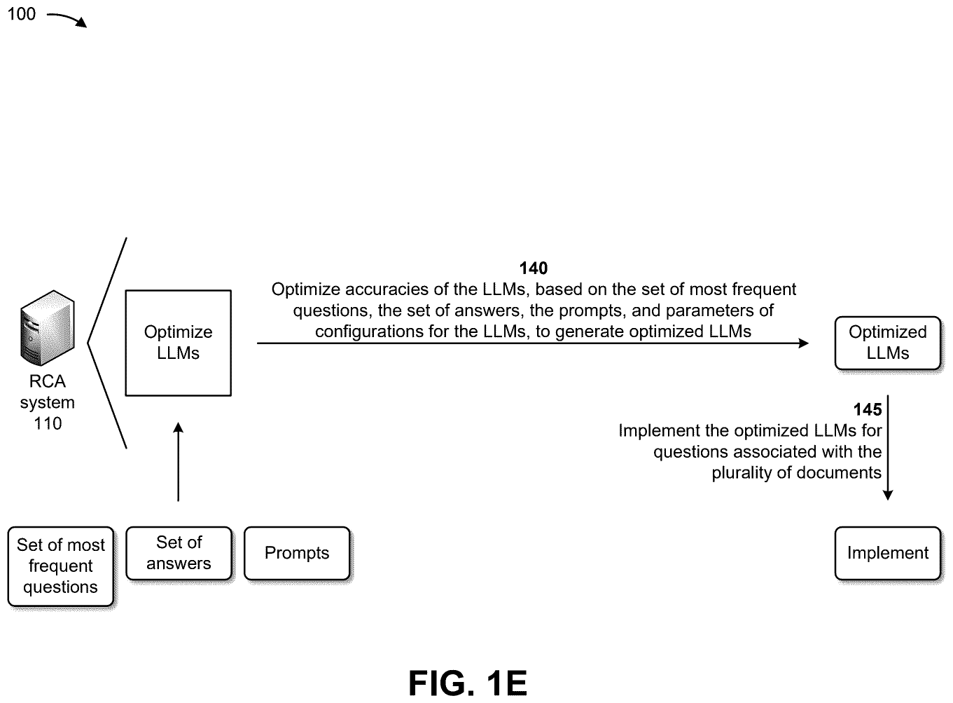

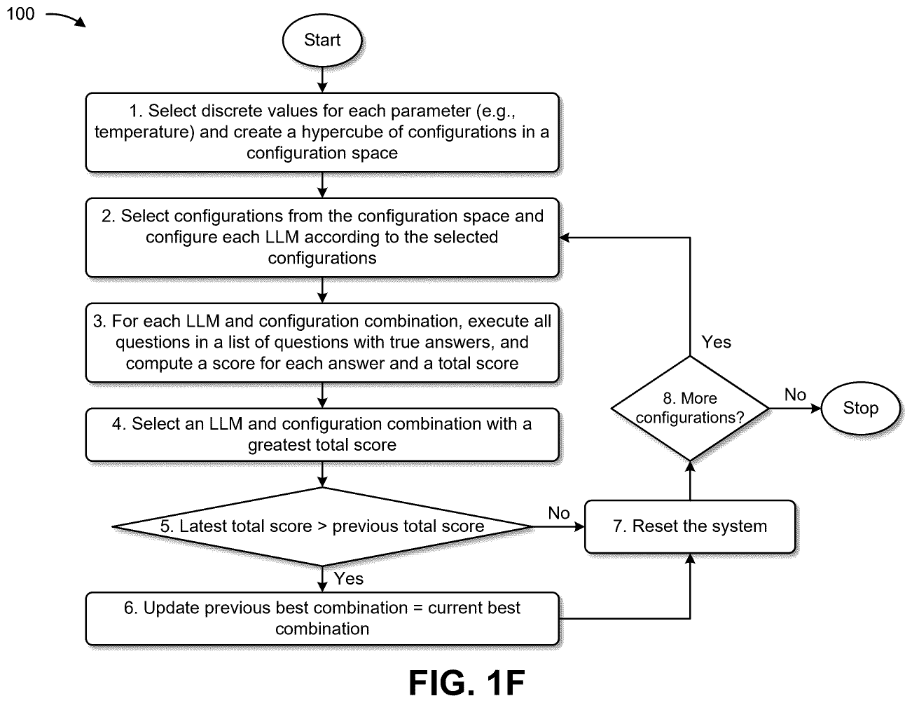

FIGS. 1A-1F are diagrams of an example 100 associated with optimizing LLM based applications. As shown in FIGS. 1A-1F, example 100 includes a data structure 105 associated with an RCA system 110. Further details of the data structure 105 and the RCA system 110 are provided elsewhere herein.

As shown in FIG. 1A, and by reference number 115, the RCA system 110 may receive a plurality of documents and a plurality of questions associated with the plurality of documents.

As shown in FIG. 1A, and by reference number 115, the RCA system 110 may receive a plurality of documents and a plurality of questions associated with the plurality of documents. For example, the data structure 105 may store a plurality of documents, such as RCA documents or documents related to other domains. The data structure 105 may also store a plurality of questions associated with the plurality of documents, such as queries about the plurality of documents, queries received by LLMs that utilize the plurality of documents, and/or the like. The RCA system 110 may receive the plurality of documents and the plurality of questions associated with the plurality of documents from the data structure 105. In some implementations, the RCA system 110 may continuously receive the plurality of documents and the plurality of questions from the data structure 105, may periodically receive the plurality of documents and the plurality of questions from the data structure 105, may receive the plurality of documents and the plurality of questions from the data structure 105 based on a request provided to the data structure 105, and/or the like. In some implementations, the RCA system 110 may ingest and digitize content of the plurality of documents and the plurality of questions. This may ensure that the plurality of documents and the plurality of questions are processed efficiently and made ready for subsequent interrogative analytical processes.

As further shown in FIG. 1A, and by reference number 120, the RCA system 110 may determine a plurality of ground truth answers corresponding to the plurality of questions. For example, the RCA system 110 may determine a correct answer (e.g., a ground truth answer) to each of the plurality of questions, and may identify one or more of the plurality of documents associated with the ground truth answer. The RCA system 110 may store file names of the one or more plurality of documents, each of the plurality of questions, and the ground truth answer in a table. In some implementations, the RCA system 110 may semantically analyze the plurality of questions and may accurately extract and save the plurality of ground truth answers corresponding to the plurality of questions. Through this method, the RCA system 110 may ascertain precise information that matches each of the plurality of questions, and may utilize natural language processing (NLP) capabilities and the plurality of documents to perform this function effectively.

In some implementations, the determination of the plurality of ground truth answers serve as a benchmark for evaluating an accuracy of an LLM in formulating responses. For example, the RCA system 110 may utilize regular expressions and NLP techniques to convert diverse answer representations to a minimum acceptable format as per predetermined parameters (e.g., “x days, y hours, z minutes”), enhancing numerical precision and enforceability. This may enable the RCA system 110 to generate answers in a standardized format that may be easily compared with the ground truth answers, leading to an automated and scalable system. This, in turn, may significantly reduce the cost and resource depletion associated with executing LLMs.

As shown in FIG. 1B, and by reference number 125, the RCA system 110 may normalize the plurality of questions and select a set of most frequent questions from the normalized plurality of questions. For example, the RCA system 110 may perform a semantic analysis of the plurality of questions to normalize the plurality of questions and generate a refined set of questions. The semantic analysis of the plurality of questions may identify single representations for questions that convey the same meaning, despite being phrased differently, resulting in a normalized plurality of questions that are easier to manage and process. In some implementations, the RCA system 110 may conduct the semantic analysis to create single representations that correspond to questions sharing identical meanings. For example, questions such as “what was the outage duration” and “how long was the network out of service” may share identical meanings and may be consolidated into one normalized question.

After generating the normalized plurality of questions, the RCA system 110 may select the set of most frequent questions from normalized plurality of questions. For example, the RCA system 110 may select normalized questions that constitute a significant portion of the plurality of questions, such as, for example, a top ten percent of questions that account for eighty percent of all inquiries. By focusing on these most frequent questions, the RCA system 110 may streamline the process for optimization and more efficient response generation. The normalization of the plurality of questions and the selection of the set of most frequent questions may define a clear set of questions for which accurate and reliable answers are most essential. This may enable the RCA system 110 to not only improve response quality but also operate more efficiently by focusing resources on the questions of greatest relevance to users.

As shown in FIG. 1C, and by reference number 130, the RCA system 110 may utilize regular expressions and NLP to generate, from the plurality of ground truth answers, a set of answers to the set of most frequent questions. For example, the RCA system 110 may apply specific regular expressions and utilize NLP techniques to normalize the plurality of ground truth answers into a minimum acceptable format. The RCA system 110 may utilize the normalized plurality of ground truth answers to generate a standardized set of answers corresponding to the set of most frequent questions. The transformation of ground truth answers into a consistent format may enable the RCA system 110 to provide accurate and scalable numeric evaluation of responses. Given the statistical nature of LLMs leading to potential variability in responses, having a pre-defined format, such as “x days, y hours, and z minutes” for outage durations, ensures that different but semantically equivalent responses are recognized as accurate. This may streamline evaluation of LLM outputs by the RCA system 110 and may aid in optimization for efficiency and accuracy.

Moreover, utilizing the combination of regular expressions and NLP allows the RCA system 110 to cater to a variety of most frequent questions, each possibly requiring its own minimal acceptable response format. By converting the wide range of potential ground truth answers into standardized formats, the RCA system 110 can more effectively provide accurate and precise responses to user queries. This provides significant improvements in the processing and retrieval capabilities of the RCA system 110, ultimately enhancing the user experience in knowledge retrieval applications. Thus, the RCA system 110 may provide a robust question and answer with enhanced efficiency, specificity, and reliability.

As shown in FIG. 1D, and by reference number 135, the RCA system 110 may dynamically select prompts for LLMs based on the set of most frequent questions and based on context provided to the LLMs for generating the set of answers. For example, while variability of LLM outputs can be controlled through parameters, the RCA system 110 may specifically instruct the LLMs through prompts about formats of returned answers. The RCA system 110 may dynamically design prompts guiding the LLMs to return answers to questions in specific formats. For example, if outage duration information is needed, the prompt may include “please for outage duration return time only, do not add any additional words.” This may enable the RCA system 110 to determine whether an answer matches a ground truth answer.

The set of most frequent questions may include many different questions. Each different question may require a prompt variation to return an answer as close to a desired format as possible. Moreover, answers returned by the LLMs may depend on context. Thus, the RCA system 110 may dynamically select prompts not only according to the question but also according to the context being provided to the LLMs for generating answers. For example, if the context exceeds a certain limit, a prompt may instruct an LLM to ignore sentences that do not discuss information related to the answer. The dynamically selected prompts may generate more accurate answers and may require less tokens for each of the questions (e.g., which results is reduced cost of executing running LLMs).

By dynamically selecting the prompts, the RCA system 110 may improve the precision and applicability of responses generated by the LLMs. By using the set of most frequent questions, the RCA system 110 can focus on optimizing responses to these high-priority inquiries. The RCA system 110 may adapt the prompts provided to the LLMs so that the generated answers match a desired format or context. For example, the RCA system 110 may instruct the LLMs to only provide answers with time durations in the specific format of hours and minutes, without additional descriptive text, and/or the like. The dynamic selection of the prompts may utilize techniques such as extracting and employing the minimum acceptable answer format through regular expressions and NLP. The dynamically selected prompts may ensure that despite statistical models employed by the LLMs, which may yield different responses for the same inquiry, the LLMs may return answers with consistent quality. The intelligent and context-aware prompt design employed by the RCA system 110 may refine the user experience with the LLMs, allowing the LLMs to generate responses that are not only accurate but also formatted in the most useful and efficient manner for the end user.

As shown in FIG. 1E, and by reference number 140, the RCA system 110 may optimize accuracies of the LLMs, based on the set of most frequent questions, the set of answers, the prompts, and parameters of configurations for the LLMs, to generate optimized LLMs. For example, the RCA system 110 utilize the set of most frequent questions, the set of answers, the prompts, and parameters of configurations for the LLMs to optimize accuracies of the LLMs and generate the optimized LLMs. The RCA system 110 may maximized cumulative accuracy scores for the set of most frequent questions across a quantity of randomly selected documents.

In one example, if the RCA system 110 utilizes P parameters, with K discrete values for each parameters, then complete configuration options for a single model (M) may be P^{K}. Each configuration may be denoted by Cⱼ, where an index j may include values from 1, . . . , P^{K}. The RCA system 110 may evaluate multiple models. If there are N models, and each model Mᵢ (where i=1, . . . , N) may utilize any configuration Cⱼ, model and configuration combinations may be denoted as MᵢCⱼ.

In order to optimize the RCA system 110 and accuracies of the LLMs, the RCA system 110 may select a model Mₒ and one of the parameters Pₒ. The RCA system 110 may fix values of the remaining (P−1) parameters at a midrange if there no prior observations on how values of each parameter impacts accuracy. However if a specific value V of a parameter Pₓ is known to maximize accuracy, the RCA system 110 may set the parameter to the specific value (e.g., Pₓ=V). The RCA system 110 may assign parameter Pₒ discrete values, p₁, p₂, . . . , p_{K}. For each of K options, the RCA system 110 may evaluate system accuracy. If the system accuracy values are a₁, a₂, . . . , a_{K} and i=argmax a(i), a maximum accuracy may be attained when Pₒ=pᵢ. The RCA system 110 may reduce the range of Pₒ to a smaller interval starting at p values before and after pᵢ and corresponding to aᵢ. (e.g., the updated Pₒ range may include [p(i−1), pᵢ, p(i+1)]).

Note that in some cases, the RCA system 110 may attain maximum system accuracy in more than one value of pᵢ. In such cases, the RCA system 110 may still reduce the range of Pₒ to an interval starting and ending at evaluated discrete values before and after the pᵢ value and corresponding the maximum system accuracy aᵢ. The RCA system 110 may evaluate the system accuracy at each of the remaining parameters. By reducing the operational range of Pₒ, the RCA system 110 may significantly reduce a search space for an optimal system configuration and still return the best possible result, while significantly reducing unnecessary computations. In some implementations, the RCA system 110 may randomly select a quantity (e.g., five percent) of additional points to perform exploratory evaluations just in case the optimal system configuration is not captured in the reduced search space. Automatically evaluating accuracy for all MᵢCⱼ combinations over the set of most frequent questions may be prohibitively expensive and unnecessary, but may be accomplished in some cases. In some implementations, the RCA system 110 may execute MᵢCⱼ combination evaluations in parallel with sufficient hardware resources.

In some implementations, an alternative approach to determining a best MᵢCⱼ combination is to use changes in score for computing a pseudo-gradient vector and selecting a direction for updating parameter values. In a simple example of such approach in a single dimension, if the system accuracy improves as we increase the parameter Pₒ value from p(i) to p(i+1), the RCA system 110 may continue increasing the parameter Pₒ value until the improvements cease. Then the RCA system 110 may select a next parameter and repeat a similar approach by changing only that parameter at a time.

In some implementations, the optimization process may include the RCA system 110 assessing various configurations and their parameters with the LLMs. For example, the RCA system may create a hypercube of the configurations in a configuration space, and may select configurations for the LLMs. The RCA system 110 may configure the LLMs according to the selected configurations to generate configured LLMs. The RCA system 110, by adjusting parameters through iterative testing, may refine search grids for parameters or may assess qualities of multiple responses from different configurations. Such iterative testing may determine the most effective settings to enhance the accuracies of the LLMs. The optimization of the LLMs may directly impact the quality of answers provided by the LLMs, potentially increasing response precision and reducing computational overhead, which could lead to cost savings and improved operational efficiency.

As further shown in FIG. 1E, and by reference number 145, the RCA system 110 may implement the optimized LLMs for questions associated with the plurality of documents. For example, the RCA system 110 may implement the optimized LLMs in a system that manages the plurality of documents, where the optimized LLMs accurately answer questions associated with the plurality of documents. The optimized LLMs may address inquiries relating to the plurality of documents, and may ensure that responses are furnished in a manner that is both accurate and efficient. The implementation of the optimized models may provide enhanced comprehension and retrieval of information from the plurality of documents, yielding improved user experiences for those interacting with the LLM based applications.

In some implementations, the optimized LLMs may be implemented with knowledge retrieval systems that designed to locate, retrieve, and present information from vast data repositories based on user queries. The knowledge retrieval systems may power search engines, recommendation systems, and digital assistants, making it easier for users to find relevant information quickly and efficiently. In some implementations, the optimized LLMs may be implemented in a retrieval-augmented generation (RAG) system that combines the power of information retrieval and neural network-based generation to enhance knowledge retrieval systems. The RAG system may retrieve relevant documents or data from a large corpus and then may utilize this information to generate responses that are informed by the retrieved content, making the output more accurate and contextually rich. A RAG system may be particularly useful in question and answer systems and chatbots, where it can pull from vast databases to provide users with precise, up-to-date answers that are directly relevant to their queries.

FIG. 1F depicts an example process associated with optimizing the accuracies of the LLMs, as described above in connection with FIG. 1E. As shown at step 1 of FIG. 1F, the RCA system 110 may select discrete values for each parameter (e.g., a temperature) and may create a hypercube of configurations in a configuration space. For example, the RCA system 110 may choose a range of temperature values and utilize them to form a configuration space that represents various permutations of parameters under which the LLM can operate. This aids in narrowing down the most effective LLM configurations for processing questions associated with the plurality of documents. As shown at step 2, the RCA system 110 may select configurations from the configuration space and may configure each LLM according to the selected configurations. The RCA system 110 may strategically select the most promising configurations based on certain criteria, adapting each LLM to that specification to assess which combination yields the best performance.

As shown at step 3 of FIG. 1F, the RCA system 110 may, for each LLM and configuration combination, execute all questions in a list of questions with true answers, and compute a score for each answer and a total score. Here, the RCA system 110 may rigorously test the effectiveness of each LLM and configuration pair by measuring their accuracy against a set of pre-established correct answers to derive a numerical estimation of their performance. As shown at step 4, the RCA system 110 may select an LLM and configuration combination with the greatest total score. This may enable the RCA system 110 to dynamically and accurately gauge an optimal setup for an LLM based on its performance in real-world scenarios provided by the plurality of documents and the associated queries.

As shown at step 5 of FIG. 1F, the RCA system 110 may determine whether the latest total score is greater than a previous total score, allowing for an iterative improvement process wherein the RCA system 110 may continuously refine the selection for the best-performing LLM configuration based on comparative scoring. As shown at step 6, if the latest score surpasses the previous score, the RCA system 110 may update the previous best combination to be the current best combination, thereby capturing and updating the optimal configuration as new data is processed and evaluated.

As shown at step 7 of FIG. 1F, the RCA system 110 may then reset the RCA system 110, preparing for another iteration of evaluations with different LLM configurations or a new set of questions, essentially reinitializing the testing environment to ensure clean and unbiased subsequent tests. As shown at step 8, the RCA system 110 may determine whether there are more configurations to evaluate. If more configurations exist, the process may repeat. Otherwise, the optimization process may conclude, having identified the most effective LLM and configuration combination for accurately answering questions from the plurality of documents.

In this way, the RCA system 110 optimizes LLM based applications. For example, the RCA system 110 may automatically improve a quality of a question and answer system or any other system that is based on LLMs. The RCA system 110 may start with a set of questions referencing specific documents, and may identify and store a correct answer (e.g., a ground truth) for each question. The RCA system 110 may include multiple configurations for the LLMs, and each configuration may include multiple parameters. The RCA system 110 may generate a search grid for discrete values of each parameter within a specified range to enable the RCA system 110 to identify a best value of a parameters space. The RCA system 110 may select multiple configurations for multiple LLMs (e.g., for three models and two configurations, the RCA system 110 may generate six model-configuration combinations). Thus, the RCA system 110 may conserve computing resources, networking resources, and/or other resources that would have otherwise been consumed by LLMs failing to properly answer questions appropriately and efficiently, LLMs providing incorrect recommendations based on poorly designed LLMs, LLMs providing irrelevant and inaccurate responses based on poorly designed LLMs, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

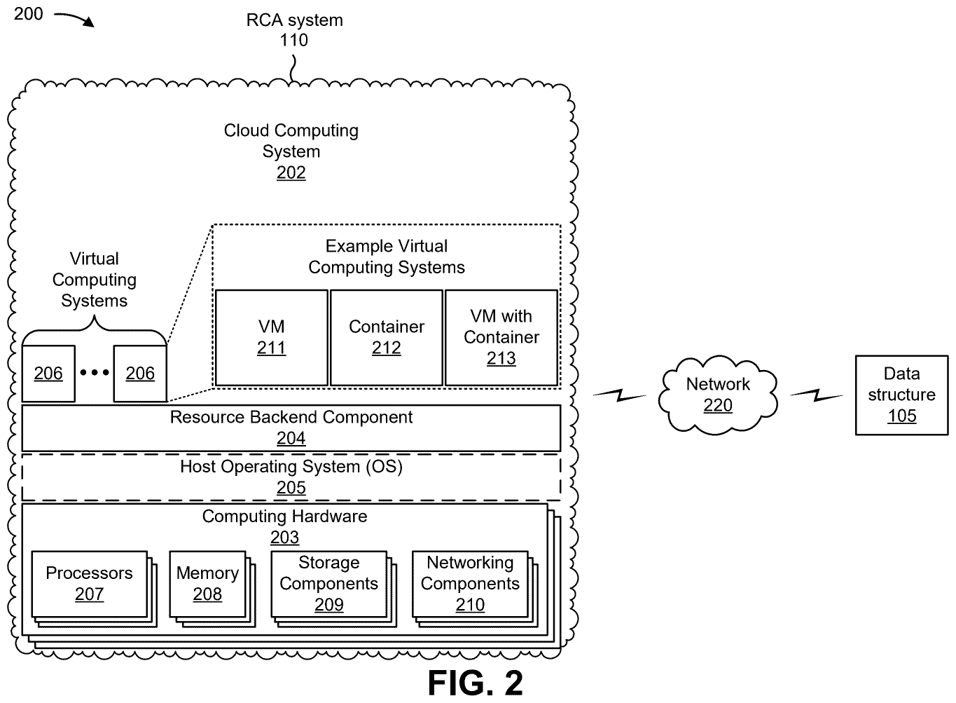

FIG. 2 is a diagram of an example environment 200 in which systems and/or methods described herein may be implemented. As shown in FIG. 2, the environment 200 may include the RCA system 110, which may include one or more elements of and/or may execute within a cloud computing system 202. The cloud computing system 202 may include one or more elements 203-213, as described in more detail below. As further shown in FIG. 2, the environment 200 may include the data structure 105 and/or a network 220. Devices and/or elements of the environment 200 may interconnect via wired connections and/or wireless connections.

The data structure 105 may include one or more devices capable of receiving, generating, storing, processing, and/or providing information, as described elsewhere herein. The data structure 105 may include a communication device and/or a computing device. For example, the data structure 105 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 105 may communicate with one or more other devices of the environment 200, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

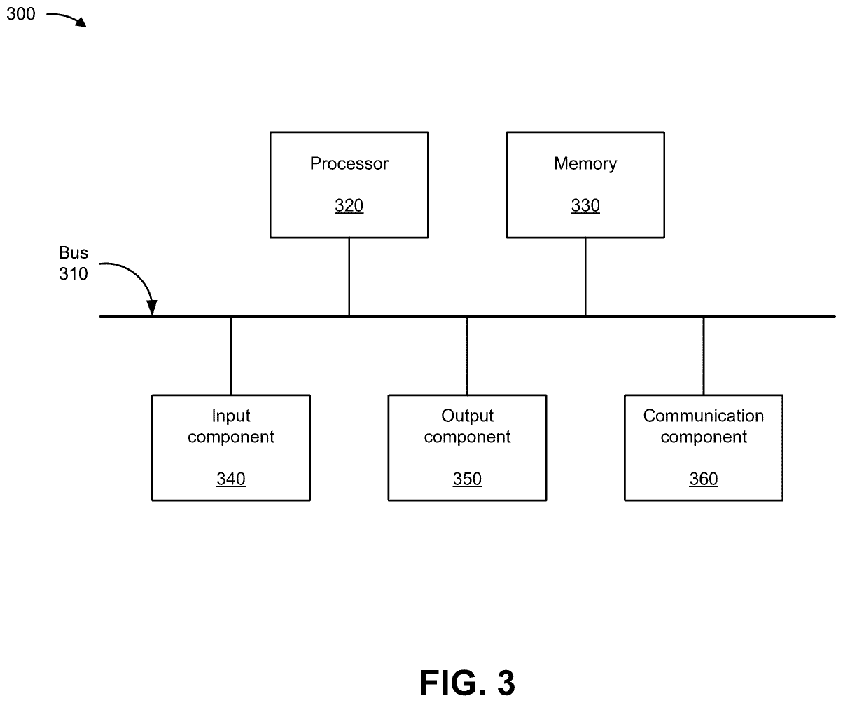

Although the RCA system 110 may include one or more elements 203-213 of the cloud computing system 202, may execute within the cloud computing system 202, and/or may be hosted within the cloud computing system 202, in some implementations, the RCA system 110 may not be cloud-based (e.g., may be implemented outside of a cloud computing system) or may be partially cloud-based. For example, the RCA system 110 may include one or more devices that are not part of the cloud computing system 202, such as the device 300 of FIG. 3, which may include a standalone server or another type of computing device. The RCA system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the data structure 105 and/or the RCA system 110. In some implementations, the data structure 105 and/or the RCA system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

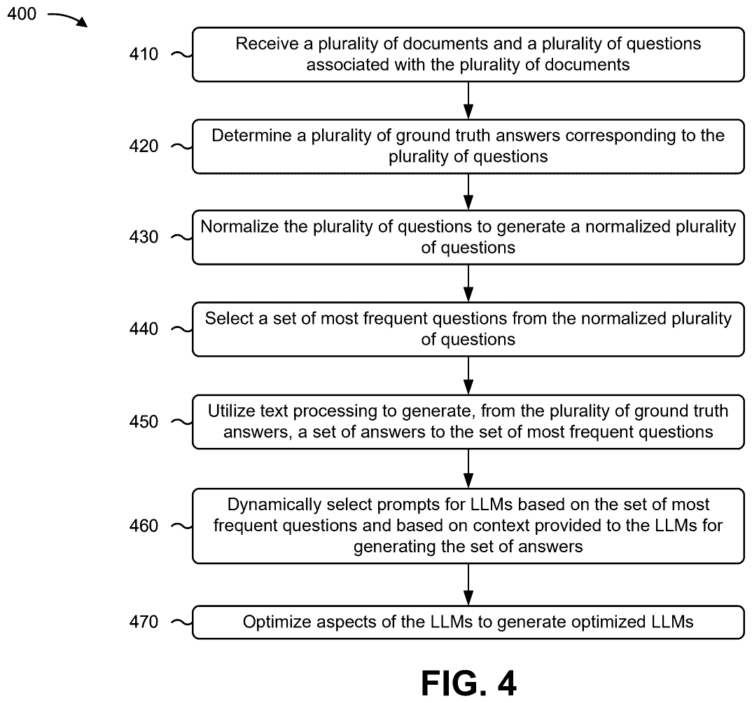

FIG. 4 is a flowchart of an example process 400 for optimizing LLM based applications. In some implementations, one or more process blocks of FIG. 4 may be performed by a device (e.g., the RCA system 110). In some implementations, one or more process blocks of FIG. 4 may be performed by another device or a group of devices separate from or including the device, such as a data structure (e.g., the data structure 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a plurality of documents and a plurality of questions associated with the plurality of documents (block 410). For example, the device may receive a plurality of documents and a plurality of questions associated with the plurality of documents, as described above.

As further shown in FIG. 4, process 400 may include determining a plurality of ground truth answers corresponding to the plurality of questions (block 420). For example, the device may determine a plurality of ground truth answers corresponding to the plurality of questions, as described above.

As further shown in FIG. 4, process 400 may include normalizing the plurality of questions to generate a normalized plurality of questions (block 430). For example, the device may normalize the plurality of questions to generate a normalized plurality of questions, as described above. In some implementations, normalizing the plurality of questions to generate the normalized plurality of questions includes performing a semantic analysis on the plurality of questions to identify single representations for the plurality of questions that have a same meaning, wherein the single representations correspond to the normalized plurality of questions.

As further shown in FIG. 4, process 400 may include selecting a set of most frequent questions from the normalized plurality of questions (block 440). For example, the device may select a set of most frequent questions from the normalized plurality of questions, as described above. In some implementations, selecting the set of most frequent questions from the normalized plurality of questions includes selecting, as the set of most frequent questions, a normalized plurality of questions that make up a particular percentage of all questions asked.

As further shown in FIG. 4, process 400 may include utilizing text processing to generate, from the plurality of ground truth answers, a set of answers to the set of most frequent questions (block 450). For example, the device may utilize regular expressions and natural language processing to generate, from the plurality of ground truth answers, a set of answers to the set of most frequent questions, as described above. In some implementations, utilizing the regular expressions and the natural language processing to generate, from the plurality of ground truth answers, the set of answers to the set of most frequent questions includes utilizing the regular expressions and the natural language processing to convert the plurality of ground truth answers to minimum acceptable formats, and generating the set of answers to the set of most frequent questions based on the minimum acceptable formats.

As further shown in FIG. 4, process 400 may include dynamically selecting prompts for LLMs based on the set of most frequent questions and based on context provided to the LLMs for generating the set of answers (block 460). For example, the device may dynamically select prompts for LLMs based on the set of most frequent questions and based on context provided to the LLMs for generating the set of answers, as described above. In some implementations, dynamically selecting the prompts for the LLMs based on the set of most frequent questions and based on the context provided to the LLMs for generating the set of answers includes dynamically selecting the prompts for LLMs that generate the set of answers to the set of most frequent questions in a specific format. In some implementations, the prompts instruct the LLMs on expected formats for the set of answers to the set of most frequent questions.

As further shown in FIG. 4, process 400 may include optimizing aspects of the LLMs, to generate optimized LLMs (block 470). For example, the device may optimize, based on the set of most frequent questions, the set of answers, the prompts, and parameters of configurations for the LLMs, accuracies of the LLMs to generate optimized LLMs, as described above. In some implementations, optimizing the accuracies of the LLMs to generate the optimized LLMs includes selecting values for the parameters, creating a hypercube of the configurations in a configuration space based on the selected values for the parameters, selecting the configurations from the configuration space, configuring the LLMs according to the selected configurations to generate configured LLMs, processing the set of most frequent questions with the configured LLMs, calculating respective scores associated with processing the set of most frequent questions with the configured LLMs and based on the set of answers, and generating the optimized LLMs based on the scores.

In some implementations, optimizing the accuracies of the LLMs to generate the optimized LLMs includes adjusting the parameters associated with the configurations through iterative testing to generate the optimized LLMs. In some implementations, optimizing the accuracies of the LLMs to generate the optimized LLMs includes refining a search grid for the parameters to generate a refined search grid for the parameters, reducing a dimensionality of a search space to generate a reduced dimensionality of the search space, and generating the optimized LLMs based on the refined search grid for the parameters and the reduced dimensionality of the search space. In some implementations, optimizing the accuracies of the LLMs to generate the optimized LLMs includes assessing qualities of multiple responses from different configurations of each of the LLMs, selecting an optimal configuration for each of the LLMs based on a numeric accuracy evaluation, and generating the optimized LLMs based on selecting the optimal configuration for each of the LLMs. In some implementations, each of the configurations includes a plurality of the parameters, and each of the parameters includes multiple options.

In some implementations, process 400 includes implementing the optimized LLMs for the plurality of questions associated with the plurality of documents. In some implementations, process 400 includes implementing at least one of the optimized LLMs in an LLM based application.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a plurality of documents and a plurality of questions associated with the plurality of documents;
determining, by the device, a plurality of ground truth answers corresponding to the plurality of questions;
normalizing, by the device, the plurality of questions to generate a normalized plurality of questions;
selecting, by the device, a set of most frequent questions from the normalized plurality of questions;
utilizing, by the device, regular expressions and natural language processing to generate, from the plurality of ground truth answers, a set of answers to the set of most frequent questions;
dynamically selecting, by the device, prompts for large language models (LLMs) based on the set of most frequent questions and based on context provided to the LLMs for generating the set of answers; and
optimizing, by the device and based on the set of most frequent questions, the set of answers, the prompts, and parameters of configurations for the LLMs, accuracies of the LLMs to generate optimized LLMs.

2. The method of claim 1, further comprising:
implementing at least one of the optimized LLMs in an LLM based application.

3. The method of claim 1, wherein normalizing the plurality of questions to generate the normalized plurality of questions comprises:
performing a semantic analysis on the plurality of questions to identify single representations for the plurality of questions that have a same meaning,
wherein the single representations correspond to the normalized plurality of questions.

4. The method of claim 1, wherein selecting the set of most frequent questions from the normalized plurality of questions comprises:
selecting, as the set of most frequent questions, a normalized plurality of questions that make up a particular percentage of all questions asked.

5. The method of claim 1, wherein utilizing the regular expressions and the natural language processing to generate, from the plurality of ground truth answers, the set of answers to the set of most frequent questions comprises:
utilizing the regular expressions and the natural language processing to convert the plurality of ground truth answers to minimum acceptable formats; and
generating the set of answers to the set of most frequent questions based on the minimum acceptable formats.

6. The method of claim 1, wherein dynamically selecting the prompts for the LLMs based on the set of most frequent questions and based on the context provided to the LLMs for generating the set of answers comprises:
dynamically selecting the prompts for LLMs that generate the set of answers to the set of most frequent questions in a specific format.

7. The method of claim 1, wherein the prompts instruct the LLMs on expected formats for the set of answers to the set of most frequent questions.

8. A device, comprising:
one or more processors configured to:
receive a plurality of documents and a plurality of questions associated with the plurality of documents;
determine a plurality of ground truth answers corresponding to the plurality of questions;
normalize the plurality of questions to generate a normalized plurality of questions;
select a set of most frequent questions from the normalized plurality of questions;
utilize regular expressions and natural language processing to generate, from the plurality of ground truth answers, a set of answers to the set of most frequent questions;
dynamically select prompts for large language models (LLMs) based on the set of most frequent questions and based on context provided to the LLMs for generating the set of answers;
optimize, based on the set of most frequent questions, the set of answers, the prompts, and parameters of configurations for the LLMs, accuracies of the LLMs to generate optimized LLMs; and
implement the optimized LLMs for the plurality of questions associated with the plurality of documents.

9. The device of claim 8, wherein the one or more processors, to optimize the accuracies of the LLMs to generate the optimized LLMs, are configured to:
select values for the parameters;
create a hypercube of the configurations in a configuration space based on the selected values for the parameters;
select the configurations from the configuration space;
configure the LLMs according to the selected configurations to generate configured LLMs;
process the set of most frequent questions with the configured LLMs;
calculate respective scores associated with processing the set of most frequent questions with the configured LLMs and based on the set of answers; and
generate the optimized LLMs based on the scores.

10. The device of claim 8, wherein the one or more processors, to optimize the accuracies of the LLMs to generate the optimized LLMs, are configured to:
adjust the parameters associated with the configurations through iterative testing to generate the optimized LLMs.

11. The device of claim 8, wherein the one or more processors, to optimize the accuracies of the LLMs to generate the optimized LLMs, are configured to:
refine a search grid for the parameters to generate a refined search grid for the parameters;
reduce a dimensionality of a search space to generate a reduced dimensionality of the search space; and
generate the optimized LLMs based on the refined search grid for the parameters and the reduced dimensionality of the search space.

12. The device of claim 8, wherein the one or more processors, to optimize the accuracies of the LLMs to generate the optimized LLMs, are configured to:
assess qualities of multiple responses from different configurations of each of the LLMs;
select an optimal configuration for each of the LLMs based on a numeric accuracy evaluation; and
generate the optimized LLMs based on selecting the optimal configuration for each of the LLMs.

13. The device of claim 8, wherein the one or more processors are further configured to:
implement at least one of the optimized LLMs in an LLM based application.

14. The device of claim 8, wherein each of the configurations includes a plurality of the parameters, and each of the parameters includes multiple options.

15. A non-transitory computer-readable medium storing a set of instructions, the set of instructions comprising:
one or more instructions that, when executed by one or more processors of a device, cause the device to:
receive a plurality of documents and a plurality of questions associated with the plurality of documents;
determine a plurality of ground truth answers corresponding to the plurality of questions;
normalize the plurality of questions to generate a normalized plurality of questions;
select a set of most frequent questions from the normalized plurality of questions;
utilize regular expressions and natural language processing to generate, from the plurality of ground truth answers, a set of answers to the set of most frequent questions;
dynamically select prompts for large language models (LLMs) based on the set of most frequent questions and based on context provided to the LLMs for generating the set of answers; and
optimize, based on the set of most frequent questions, the set of answers, the prompts, and parameters of configurations for the LLMs, accuracies of the LLMs to generate optimized LLMs,
wherein each of the configurations includes a plurality of the parameters, and each of the parameters includes multiple options.

16. The non-transitory computer-readable medium of claim 15, wherein the one or more instructions, that cause the device to normalize the plurality of questions to generate the normalized plurality of questions, cause the device to:
perform a semantic analysis on the plurality of questions to identify single representations for the plurality of questions that have a same meaning,
wherein the single representations correspond to the normalized plurality of questions.

17. The non-transitory computer-readable medium of claim 15, wherein the one or more instructions, that cause the device to select the set of most frequent questions from the normalized plurality of questions, cause the device to:
select, as the set of most frequent questions, normalized plurality of questions that make up a defined percentage of all questions asked.

18. The non-transitory computer-readable medium of claim 15, wherein the one or more instructions, that cause the device to utilize the regular expressions and the natural language processing to generate, from the plurality of ground truth answers, the set of answers to the set of most frequent questions, cause the device to:
utilize the regular expressions and the natural language processing to convert the plurality of ground truth answers to minimum acceptable formats; and
generate the set of answers to the set of most frequent questions based on the minimum acceptable formats.

19. The non-transitory computer-readable medium of claim 15, wherein the one or more instructions, that cause the device to dynamically select the prompts for the LLMs based on the set of most frequent questions and based on the context provided to the LLMs for generating the set of answers, cause the device to:
dynamically select the prompts for the LLMs that generate the set of answers to the set of most frequent questions in a specific format.

20. The non-transitory computer-readable medium of claim 15, wherein the one or more instructions, that cause the device to optimize the accuracies of the LLMs to generate the optimized LLMs, cause the device to:
select values for the parameters;
create a hypercube of the configurations in a configuration space based on the selected values for the parameters;
select the configurations from the configuration space;
configure the LLMs according to the selected configurations to generate configured LLMs;
process the set of most frequent questions with the configured LLMs;
calculate scores associated with processing the set of most frequent questions with the configured LLMs and based on the set of answers; and
generate the optimized LLMs based on the scores.
